(19) United States
(12) Patent Application Publication
(10) Pub. No.: US 2007/0154258 A1
(43) Pub. Date: Jul. 5, 2007

(54) Fitting with an arresting device

(76) Inventor: Friedrich Knapp, Vaterstetten (DE)

Correspondence Address: HENRY M FEIEREISEN, LLC, 350 FIFTH AVENUE, SUITE 4714, NEW YORK, NY, 10118, US

(21) Appl. No.: 10/545,529

(22) PCT Filed: Feb. 13, 2004
(86) PCT No.: PCT/DE04/00275

§ 371 Date: May 16, 2006

(30) Foreign Application Priority Data
Mar. 13, 2003 (DE) 103-06-201.7

(51) Int. Cl. B25G 3/00

(52) U.S. Cl. 403/331

(57) ABSTRACT

The invention relates to a fitting for joining two parts. The fitting consists of two plate-shaped fitting parts (1a, 1b), which are screwed onto the parts to be joined by means of fastening screws. Each fitting part (1a, 1b) comprises at least one lateral slot-shaped recess (2). A first bore hole (3) is provided opposite the slot-shaped recess (2) and, when the fitting is assembled, a first tension screw (4) is screwed in through this bore hole until the screw head projects with a predetermined measure. The slot-shaped recess (2) is undercut with a predetermined measure so that, when the fitting is assembled, the recess (2) of one fitting part (1a) engages behind the projecting screw head of the other fitting part (1b), and both plate-shaped fitting parts (1a, 1b) are pressed against one another in a planar manner. A springy arresting device (6) is also provided that prevents an unintentional opening of the fitting.

The invention relates to a fitting for joining two parts. Several fittings for such joints have been known yet. A fitting having a cranked spring strip and being sunk in a relatively deep recess is described in DE 1 779 745. The cranked end portion of the spring strip is provided with an longitudinal slot for receiving a clamping screw. The clamping screw is screwed into a structural member so that, when the fitting is assembled, the longitudinal slot is under the head of the clamping screw. Such an arrangement is suited for small loads only and rigid cranks also tend to be bent up under load. Another disadvantage of fittings having cranked end portions is that they are relatively great in height and therefore, the cross section of a plate or that of a square timber at its length side is reduced by the recess for the fitting. In general, fittings of such type are arranged so that both parts of them are moved to each other and away from each other for assembling and disassembling, respectively. Usually, a separate arresting device is provided to prevent an unintentional opening of the fitting.

Another fitting for joining structural members is described in DE 44 21 398 A1. This fitting is composed of at least two bar-shaped or plate-shaped parts, each of which is fixed to one of the structural members to be joined.

Both fitting parts have a substantially rectangular cross section and are uniform in thickness, wherein the end portion of one of them is cranked to form a joining tongue and extends in parallel to the residual portion serving as basis of the joint. This fitting is remarkably stronger than that described in DE 1 779 749, but also requires a separate arresting device for preventing an unintentional opening.

Object of the invention is to provide a fitting for joining structural members, which can be produced easily and low in cost and requires a receiving recess very small in depth only. Furthermore, this fitting shall be very stable and safeguarded to unintentional opening.

This object is achieved by a fitting according to claim 1.

A fitting for joining structural members is composed of plate-shaped parts preferably made of metal. Each of these parts is fixed by fastening screws to the respective one of structural members to be joined. They are evenly formed and are provided with at least one lateral slot-shaped recess. A first bore hole is provided opposite to the slot-shaped recess and, when the fitting part is fixed to the structural member, a first tension screw is screwed into the structural element through this bore hole until the head of it projects with a predetermined measure. The slot-shaped recess is undercut with a predetermined measure so that, when the fitting is assembled, the recess of one fitting part engages behind the projecting screw head of the other fitting part, and both plate-shaped fitting parts are pressed against one another in a planar manner. A second bore hole is provided opposite to the slot-shaped recess (2), but closer to that than the first bore hole, through which a second tension screw (5) having a countersunk head is screwed into that structural member so that the top surface of the screw head is below the top surface of the fitting part and does not contact the bottom surface of the other fitting part. Furthermore, the fitting according to this invention comprises at least one arresting device the features of which are as follows:

The outermost portion of the fitting part has the form of a wedge, wherein at least one of its lateral surfaces must be oblique. Preferably, both lateral surfaces of the outermost portion of the fitting part are inclined to each other to the front end of the fitting part. The oblique surface, hereinafter called wedge flank, comprises, at its basis, an engaging recess directed to the centreline of the fitting part. A springy element made of spring wire is arranged on the other of the fitting parts. At least one portion of the springy element is formed as arresting portion, the function of which will be described now.

For example, the end of the springy element is formed as arresting portion and shaped so that it engages in a receiving recess of that fitting part and contacts the wedge flank of the other fitting part. When both fitting parts are moved to each other for assembling, the arresting portion slides along the wedge flank while being pressed to that by the spring force of the springy element, and finally engages the recess in the wedge flank. An expert experienced in the field of fittings will certainly know that the springy element having the arresting portion can be modified as far as it is freely movable and appropriately elastic to fulfil the function wanted.

This fitting comprises several advantages which will be described now.

The most important advantage of this fitting is that it is especially flat and therefore, does not require a deep receiving recess to be cut into the structural element, which otherwise would reduce the cross section of that. Another advantage is that it can be produced in a great variety of sizes.

Sheets of different thickness, which are used as semifinished materials for making the fittings, and standard screws suitable for fixing the fittings are available commercially. The fitting according to the present invention is simple in design and must be constructed so as to be capable of receiving such forces which the strength of wood or resin allows for holding the screws. Therefore, a structure-relevant permission can be gained within a short time or is not necessary at all. The screws can be substituted by other fixing elements such as tie rods, if great forces have to be received. Unintentional opening of the assembly, that is separating both fitting parts from each other, is prevented by using the arresting device mentioned above, as the springy element which holds both fitting parts pressed to each other can be removed only by damaging, i.e. by a plastic deformation. As the springy element is arranged on the fitting itself and engages automatically when two fitting parts are connected to each other, the arresting device guarantees a high functional safety.

According to claim 2, the engaging recess is undercut. The undercut guarantees a form-locking connection to be gained and prevents the arresting portion of the springy element from being drawn out from the engaging recess against the spring force.

According to claim 3, an especially simple and functionally very safe arresting element is disclosed, which is made from spring wire and formed to a u-shaped piece the end portions of which are bent upwardly by 90 degrees. The springy element is arranged on the bottom surface of the fitting part and accommodated in a recess, wherein the bent end portions of which are hold in lateral slots and extent beyond the top surface of this fitting part so that they contact the wedge flanks of a corresponding counter-fitting part.

According to claim 4, the springy element has a circular or rectangular cross section and can be made from commercial spring wire.

According to claim 5, the arresting device is provided with a recess for a tool to be used for removing the springy element from the assembly. However, removal of the springy element is only possible by destroying or deforming it.

According to claim 6, the arresting device is alternately arranged on both fitting parts so that an unintentional opening of the assembly is prevented effectively.

Now, the invention will be described with reference to the accompanying drawings by using an example.

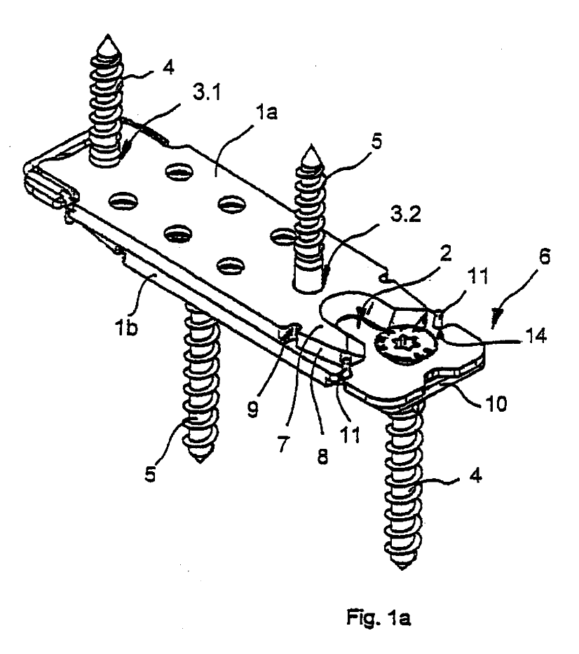

FIGS. 1a and 1b show this fitting in the opened and closed state, respectively.

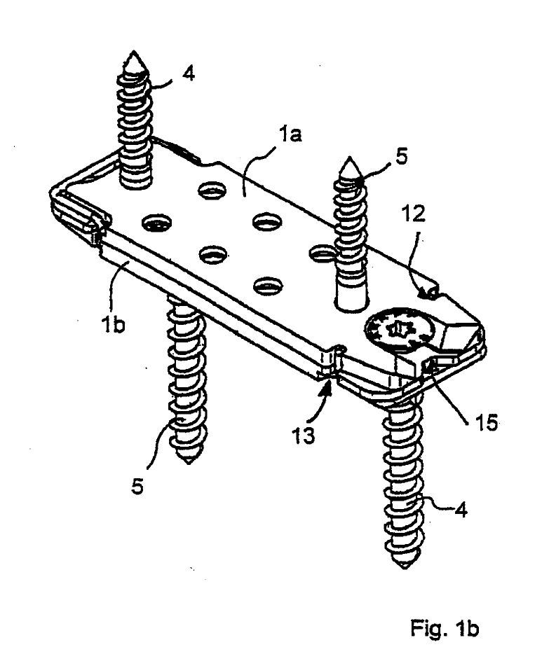

FIG. 2 shows in detail one of the two fitting parts.

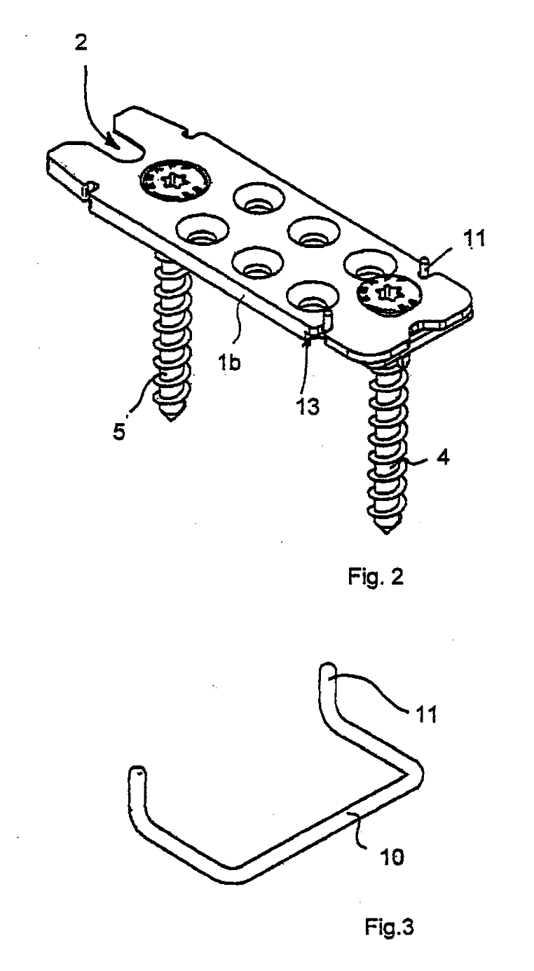

FIG. 3 shows the springy element of the arresting device.

FIGS. 1a and 1b show a fitting 1 comprising two plate-shaped rectangular parts. Each of this evenly formed fitting parts is provided at one of its narrow sides with a slot-shaped recess 2 having a dovetailed cross section. A countersunk tension screw 4 is screwed through a bore hole 3 into a structural member (not shown) so that the screw head engages the dovetailed flanks of the recess, wherein the countersunk angle of the screw head corresponds to the angle of the flanks. By this arrangement, both fitting parts are also pressed to each other. A countersunk tension screw 5 is screwed through another bore hole 3 into the structural member to increase the fixing force. The bore hole 3 is countersunk so that the head of the tension screw 5 is below the surface of the fitting part and does not contact the engaging surface of the other fitting part.

Now, structure and function of the arresting means will be described.

The end portion of fitting part 1a has a double-wedged form. Each of the inclined sides of this portion, hereinafter called wedge flank 8, is provided at its basis with an engaging recess 9 extending to the centreline of the fitting part. The fitting part 1b is provided with springy element 10. This element made of spring wire has U-form and its end portions are bent upwardly by 90 degrees. It is arranged on the bottom surface of the fitting part and accommodated in a recess 13 so that it can be moved easily. The bent end portions 11 of the springy element 10 are engaged in lateral slots 14 of the fitting part and extent beyond the top surface of the fitting part so that they contact the wedge flanks 8 of the other fitting part. An undercut 12 within each of the engaging recesses 9 gives an especially safe hold for the respective arresting portion 11. Therefore, the springy element 10 is safely held and can only be removed by using a tool such as screw driver or a hook put into a recess 15. Removal of the springy element 10 is only possible by deforming it completely. FIG. 2 shows the lower one of the fittings parts according to FIG. 1 to make the arrangement of the springy element 10 visible.

FIG. 3 shows the springy element 10 having the bent end portions 11.

An expert experienced in the field of fittings will be able to certainly realize that this invention can be modified by changing the form of the slot-shaped recess 2 in agreement with a suitable form of the screw head, for example. There is also the possibility to use fitting parts which are provided with two ore more recesses 2 and to choose the number of arresting means 6 based on technological demand.

1. A fitting for joining structural members, which comprises two plate-shaped parts (1a, 1b) each of which is fixed by screws to the respective one of the structural members to be jointed together, wherein each fitting part (1a, 1b) is evenly formed and provided with at least one lateral slot-shaped recess (2),
a first bore hole (3.1) is formed opposite to the slot-shaped recess (2), through which a first tension screw (4) is screwed into a structural member so that the head of the screw projects with a predetermined measure, wherein
the slot-shaped recess (2) is undercut with a predetermined measure so that, when the fitting is assembled, the recess (2) of one fitting part (1a) engages behind the projecting screw head of the other fitting part (1b), and both plate-shaped fitting parts (1a, 1b) are pressed against one another in a planar manner,
each of the fitting parts is provided with a second bore hole (3.2) arranged also opposite to the slot-shaped recess (2), but closer to that than the first bore hole (3.1), through which a second tension screw (5) having a countersunk head is screwed into that structural member, and
at least one arresting device (6) is provided, the features of which are as follows:
one of the longitudinal end portions of the fitting part (1a) is formed like a wedge,
the basis of one of the wedge flanks (8) is provided with a recess (9) and a springy element made of spring wire (10) is arranged on the fitting part (1b), wherein at least one portion of the springy element (10) is formed as an arresting portion (11), which, when the fitting is assembled, slides along the wedge flank (8) under the force of the springy element (10) and finally engages the recess (9).

2. A fitting according to claim 1, wherein the recess (9) comprises an undercut (12) for preventing the arresting portion (11) from being drawn out from the recess (9) against the force of the springy element (10).

3. A fitting according to claim 1, wherein the springy element (10) is made from spring wire to a u-shaped piece the ends of which are bent upwardly by 90 degrees, wherein the springy element is accommodated in a recess (13) on the bottom surface of the fittings element (1b), with the arresting portions of which being held in lateral slots (14) of the fitting part (1b) so that they extent beyond the top surface of the fitting part (1b) and contact the wedge flanks (8) of the fitting part (1a).

4. A fitting according to claim 1, wherein the springy element (10) has a circular or a rectangular cross section.

5. A fitting according to claim 1, wherein the arresting device comprises a recess (15) for a tool to be used for deforming or damaging the springy element (10) when the assembly is to be dismantled.

6. A fitting according to claim 1, wherein the arresting device (6) is arranged alternately on both fitting parts (1a, 1b).
